(19) United States
(12) Patent Application Publication
(10) Pub. No.: US 2013/0144802 A1
(43) Pub. Date: Jun. 6, 2013

(54) PERSONALIZING AGGREGATED ONLINE REVIEWS

(71) Applicants: Judith Helen Bank, Morrisville, NC (US); Lisa Marie Wood Bradley, Cary, NC (US); Tolga Oral, Winchester, MA (US); Lin Sun, Morrisville, NC (US); ChunHui Yang, Durham, NC (US)

(72) Inventors: Judith Helen Bank, Morrisville, NC (US); Lisa Marie Wood Bradley, Cary, NC (US); Tolga Oral, Winchester, MA (US); Lin Sun, Morrisville, NC (US); ChunHui Yang, Durham, NC (US)

(73) Assignee: International Business Machines Corporation, Armonk, NY (US)

(21) Appl. No.: 13/309,390

(22) Filed: Dec. 1, 2011

(51) Int. Cl. G06Q 30/02

(52) U.S. Cl. 705/347

(57) ABSTRACT

A method for processing reviews includes identifying reviews that match a request criterion in a request from a user; filtering the identified reviews using preferences and characteristics of the user; and outputting a compilation of only those reviews filtered according to preference and characteristics of the user.

### BACKGROUND

The present invention relates to online reviews, and more specifically, to aggregated online reviews that average the ratings of each review.

Online reviews seek to assist customers to determine which products or services are best suited for them. These reviews are helpful to online customers as well as customers shopping at brick and mortar businesses. Typically, an online review is provided by someone with experience with a particular product or service. Often, a reviewer will rate the product or service through a standardized rating system provided in the review's platform and also provide commentary about the product or service.

### BRIEF SUMMARY

A method for processing reviews includes identifying reviews that match a request criterion in a request from a user; filtering the identified reviews using preferences and characteristics of the user; and outputting a compilation of only those reviews filtered according to preference and characteristics of the user.

A system for processing reviews includes at least one processor to access and execute computer readable instructions stored on a computer readable storage medium; the computer readable instructions to cause the at least one processor to, upon execution of the computer readable instructions: identify reviews that match a request criterion in a request from a user; filter the identified reviews using preferences and characteristics of the user; and output a compilation of only those reviews filtered according to preference and characteristics of the user.

A computer program product includes a computer readable storage medium. The computer readable storage medium has computer readable program code embodied therewith, which includes computer readable program code to identify reviews that match a request criterion in a request from a user; computer readable program code to filter the identified reviews using preferences and characteristics of the user; and computer readable program code to output a compilation of only those reviews filtered according to preference and characteristics of the user.

### BRIEF DESCRIPTION OF THE SEVERAL VIEWS OF THE DRAWINGS

The accompanying drawings illustrate various examples of the principles described herein and are a part of the specification. The illustrated examples are merely examples and do not limit the scope of the claims.

FIG. 1a is a diagram showing an illustrative system for processing reviews, according to one example of principles described herein.

FIG. 1b is a diagram showing an illustrative system for processing reviews, according to one example of principles described herein.

FIG. 2 is a diagram showing an illustrative display, according to one example of principles described herein.

FIG. 3 is a diagram showing an illustrative customized display, according to one example of principles described herein.

FIG. 4 is a flowchart showing an illustrative process for personalizing aggregated reviews, according to one example of principles described herein.

FIG. 5 is a diagram showing an illustrative user profile, according to one example of principles described herein.

FIG. 6 is a diagram showing an illustrative review, according to one example of principles described herein.

FIG. 7 is a diagram showing an illustrative system for processing reviews, according to one example of principles described herein.

FIG. 8 is a diagram showing an illustrative customized display, according to one example of principles described herein.

### DETAILED DESCRIPTION

The present specification discloses a method and system for customizing a display of product or service reviews for a user based on that user's characteristics. From among the available reviews of the product or service in question, reviews are identified that match characteristics or stated preferences of the user requesting the reviews. In this way, the reviews provided to the requesting user will be more relevant and useful.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

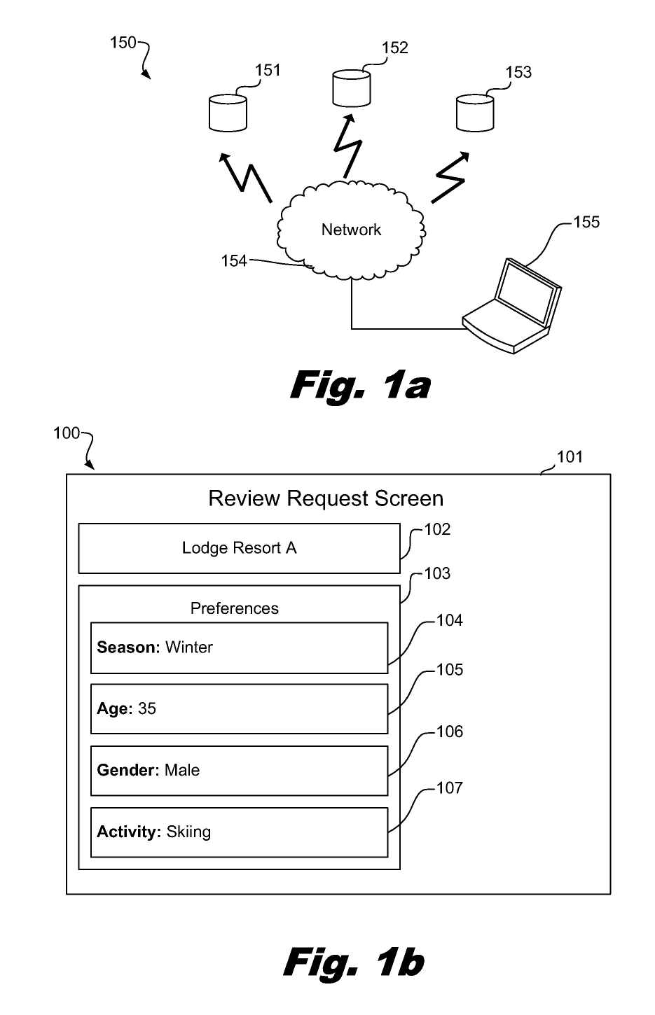

Referring now to the figures, FIG. 1a is a diagram showing an illustrative system (150) for processing and displaying reviews. A user interface (155), such as a personal computer, may be used to send requests for product or service reviews. The user interface may access databases (151), (152), (153) or other sources of reviews through the internet (154). In some examples, the source of the reviews is local to the user interface (155). After sending a review request, the user interface (155) may compile filtered reviews for display to the user. The system (150) may be maintained by a retailer, service provider, or a third party.

In the example of FIG. 1b, a display device (101) shows a screen that displays a request field (102) in which a user may identify or otherwise provide at least one criterion for the good or service about which reviews are desired. In the example of FIG. 1b, the user is requesting reviews of a particular hotel or lodging provider, identified a “Lodge Resort A.”

The system also allows the user to input characteristics or preferences (103) that the system uses to identify reviews that might be particularly useful to the user and filter out reviews that are likely irrelevant to the user. Illustrative examples of such characteristics and preferences are shown in the display of FIG. 1b; however, other criteria may be included. The preferences include the season (104) that the user intends to use the lodge and the activity (107) that the user intends to pursue while staying at the lodge. The characteristics of the user include the user's age (105) and the user's gender (106).

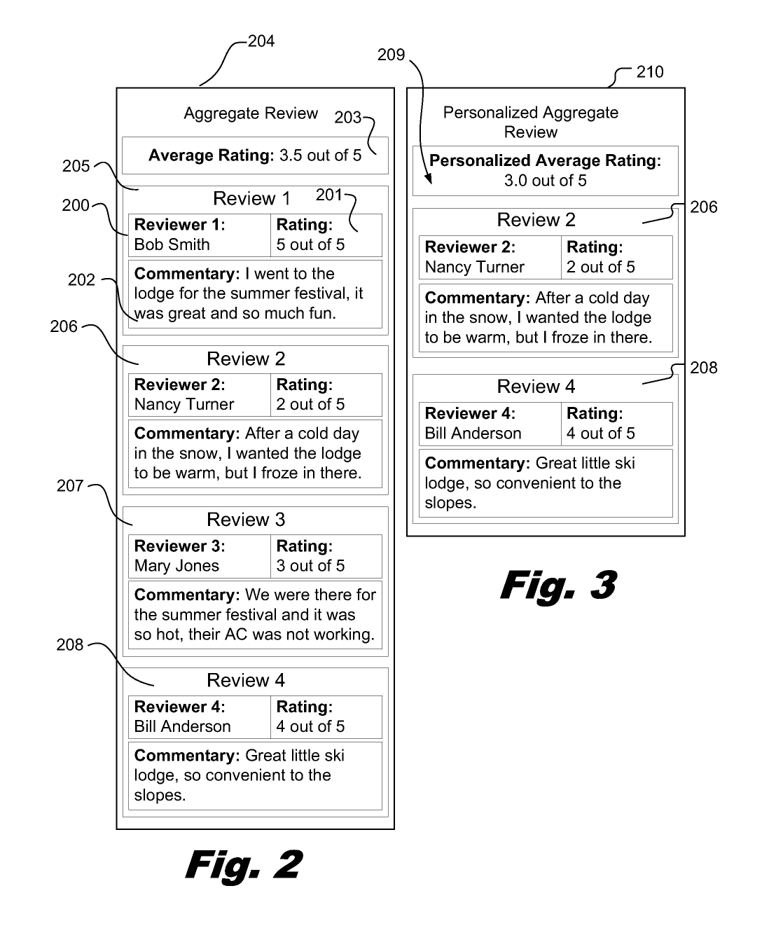

The system will select all reviews available that pertain to the criterion or the identified product or service (102), which, in this example, is “Lodge Resort A.” Reviews may be selected both locally or retrieved from other websites or databases. Illustrative reviews that may be selected by the system are shown in FIG. 2. Each review may contain a review name (200), a rating (201), commentary (202) about the product or service, and other information useful to the user. The numeric ratings (201) from each review may be averaged and displayed as an average aggregate rating (203). The overall report containing the reviews about the criterion may be referred to as an aggregate review (204).

After the reviews associated with the criterion are selected, the system may determine which reviews within the aggregate review (204) are applicable to the user based on the user's preferences and characteristics. Those preferences and characteristics are then used to customize a display that is personalized for the user. The user's preferences and characteristics may be used to include reviews or exclude reviews. In some examples, the user's preferences and characteristics may be used to both include and exclude reviews for the personalized display. In some examples, the preferences and characteristics are also used to determine the order the reviews are displayed to the user.

Text analytics, natural language processing, indexing, or other programmed intelligence may be used to match a review's text or metadata to the preferences and characteristics provided by the user. The metadata may include information found in the review's commentary, review's origin, time or season that the review was written, location from where the review was written, name of the reviewer, tags, images, language, information displayed to the user, and information hidden from the user. The system may compare the preferences and characteristics of the user to the reviews' structured or unstructured metadata. The metadata in the reviews may also be found in commentary provided by the review.

The preferences and characteristics provided by the user may exactly match terms in the review's commentary. Alternatively, the system may associate preferences and characteristics with text in the reviews that contains similar root words. In some examples, the system may use dictionaries and/or thesauruses to match the commentaries' meaning with the preferences and characteristics of the user instead of just the literally meaning of the words contained in the reviews. Also, the system may have foreign language translation abilities to glean meaning from reviews that are not in the user's native language.

For the sake of simplicity, FIG. 3 discloses reviews deemed relevant by the system based only on the season preference (104) illustrated in FIG. 1b. For example, in FIG. 1b, the user identified that he intended to visit the lodge during the winter season. In FIG. 2, the commentary (202) of Review No. 1 (205) discloses that the reviewer was at Lodge Resort A during the summer. Thus, Review No. 1 does not match the season preference identified by the user, and the system may remove Review No. 1.

Review No. 2 (206) discloses the terms “snow,” “cold,” and “froze,” which may be associated with the winter. Thus, Review No. 2 (206) may be deemed to match the season preference identified by the user, and the system may retain Review No. 2. Although, the commentary of Review No. 2 also includes the term “warm,” which may not be associated with winter, the system may nonetheless retain Review No. 2 (206) because at least one of the terms “snow,” “cold,” and “froze” likely have a strong correlation with winter.

Review No. 3 (207) does not include any terms that the system could associate with the winter season. Further, the terms “summer” and “hot” are used which indicate the reviewer was not at Lodge Resort A during the winter. Thus, the system may remove Review No. 3 (207).

In Review No. 4 (208), the system may determine that “slopes” and “ski” indicate the review is associated with the winter season and retain Review No. 4 (208).

In some examples, the system may also take into consideration the season or time of year that a review was created when matching preferences to the reviews. For example, the system may create an assumption that reviews are created shortly after the reviewer experienced the product or service. Thus, the system may consider a review created in January to match a winter season preference and, for the example of FIG. 1b, retain that review.

Referring now to the example of FIG. 3, only Review Nos. 2 and 4 (206), (208) are included. The ratings of just these reviews are averaged to form a personalized average rating (209). The retained or preferred reviews may collectively form a personalized aggregate review (210).

While the above example used a single preference of season to sort out reviews based on the user's needs, any or all of the other preferences and characteristics provided by the user could have also been used. In some examples, a single preference or characteristic is compared against the reviews in the aggregate review (204), and in other examples, multiple preferences and characteristics are used. When multiple preferences are used, the system may include only those reviews that match a single preference, two or more preferences, or all of the preferences. In some examples, certain preferences may be weighted such that a review that matches a weighted preference is automatically included, while a review that matches only one unweighted preference is excluded.

The personalized aggregate review may be more relevant to the user's needs. In the examples shown in FIGS. 2 and 3, both disclose reviews that meet the user's review criteria. However, some of the reviews disclosed in FIG. 2 focus on details that may be unhelpful to the user. Further, the averaged aggregate rating is likely influenced by factors that may be unimportant to the user. The personalized aggregate review on the other hand saves the user valuable time by presenting only those reviews that are most relevant to the user's needs. Further, the averaged personalized rating is more likely to be influenced by factors important to the user. While the examples disclosed in FIGS. 2 and 3 only display a handful of reviews, the aggregate review (204) may potentially contain any number, such as hundreds or thousands, of reviews. Thus, presenting only relevant reviews in the personalized aggregate review may provide the user a significant time savings.

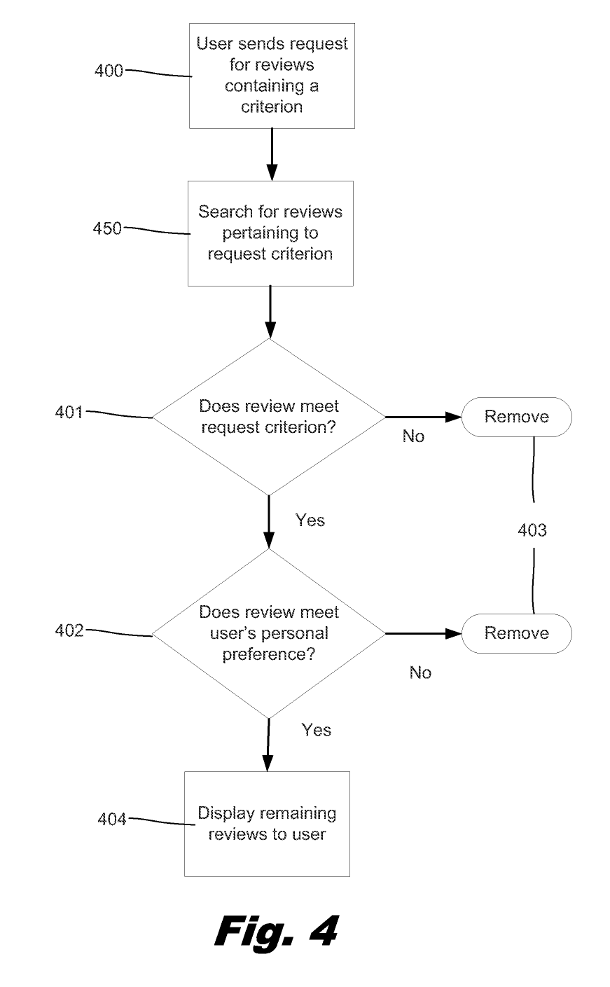

FIG. 4 is a flowchart showing an illustrative procedure followed by the system in some examples. The user may send (400) a request for reviews specifying at least one product or service or other criterion of a product or service about which reviews are desired. The user may send the request through a web portal, a computer, portable device, a wireless device, or a combination thereof. The system may search (450) for reviews that pertain to the request criterion and select those reviews that match the criterion. In some examples, the reviews are located in a single directory, multiple directories, online resources, caches, hard drives, tangible memory storage, local area networks, wireless local area networks, virtual private networks, or other suitable locations.

Next, the system determines (401) if each review matches the request criterion. For those reviews that fail to match the review criterion, the review may be removed (403). The system then determines (402) if the remaining reviews also match at least one of the user's preferences or characteristics. Those reviews that fail to match up with a user preference or characteristic may also be removed (403). The reviews that survive may be considered relevant reviews and may be displayed (404) in a format available to the user, such as through a computer monitor, wireless device, a printed display, visual display, a graphical display, or combinations thereof.

In some examples, both the unfiltered, aggregate review (204) and the filtered, personalized aggregate review (210) are displayed to the user. While the personalized aggregate review is likely more relevant to the user's needs, the user may decide after a brief study of the aggregate review to modify his preferences and, thereby, adjust the personalized aggregate review. For example, a user requesting reviews about a restaurant may include a preference about the food's expense. However, after receiving the aggregate review (204) and personalized aggregate review (210), the user may discover that the aggregate review (204) includes another factor, such as the quality of the food, that is absent from the personalized aggregate review (210) that is also relevant to the user. Thus, the user may add another preference about the food and resend the request.

In some examples, the user may first send a request specifying at least one review criterion. After receiving the aggregate review (204), the user may then have an opportunity to input at least one preference, which is then compared to each review within the aggregate review.

In yet other illustrative examples, the system may give the user an opportunity to refine his or her preferences after the system displays the personalized aggregate review (210). At this stage, the system may allow the user to apply a preference to the entire aggregate review or just those reviews already displayed in the personalized aggregated review (210) and, thus, narrow the results.

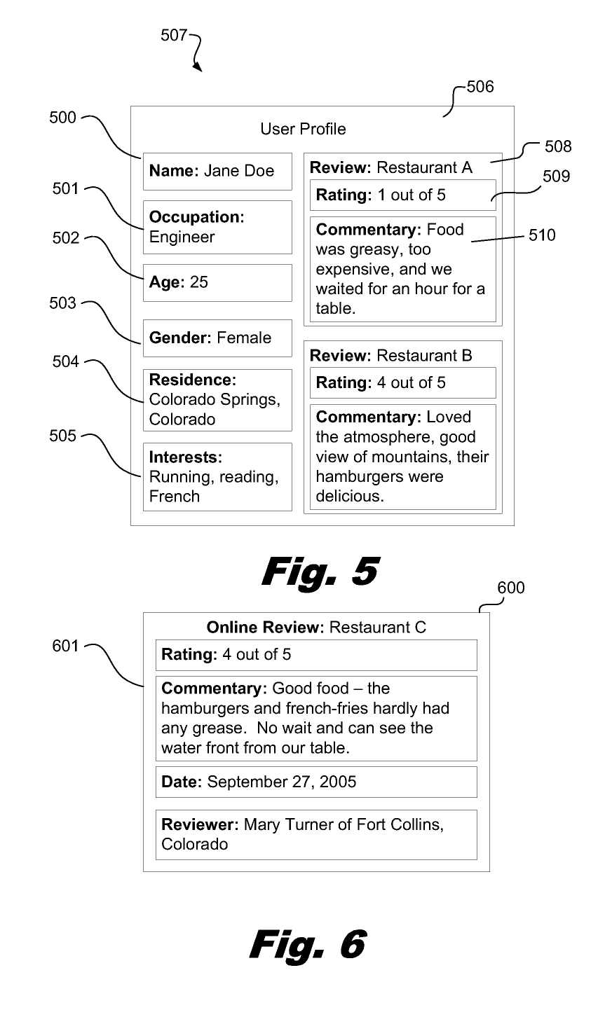

In the example of FIG. 5, the system includes an option for a user to create a profile (506), which may include information such as a user's name (500), occupation (501) age (502), gender (503), residence (504), interests (505), and other personal information. The system may also give the user a mechanism to provide reviews of his or her own that may be stored in the user's profile (506). The user's reviews (507) may contain information such as name (508) of the product or service, rating (509) of the product or service, and commentary (510). In some examples, the system may give the user access to other reviews within the system, where the user may rate or comment on other reviews. Also, in some examples, the user may designate themselves as associated with groups, clubs, organizations, or people. Other information generally contained in user profiles may also be included.

All of the information in the user's profile (506) may automatically or selectively be designated a user preference. Thus, if the user makes a review request specifying “coat” as the review criterion, the system may generate an aggregate review matched against “coat.” Then, each review within the aggregate review may be further matched or filtered against the information in the user's profile. For example, the user in the example shown in FIG. 5 is a 25 year old female from Colorado Springs. Without the user's express request, the system may automatically exclude coats for men, coats generally appealing to elderly people, and coats better suited for warmer climates.

Also, in the example of FIG. 5, the user specifies “running” as an interest, therefore, the personalized aggregate review may include some coats for running that might have otherwise been excluded. Further, the system may recognize the time of year or season when the user made the request for “coat” and may adjust the personalized aggregate review to include only coats suitable for that season. In some examples, reviews that match more than one preference may be placed earlier or higher in the display. In some examples, the user has an option to exclude certain information as a preference, which may be helpful when the user is reviewing products intended to be a gift for someone else, looking for a good deal on a product that is out of season, or looking for a product or service intended for use while traveling. In some examples, only the current content of the user's profile may be gleaned for preferences since the interests and needs of the user changes over time, and the system is configured to glean the most relevant information to be the user's preferences.

In the example of FIG. 5, the user's profile contains reviews with commentary authored by the user. Text analytics or other programmed intelligence may glean preferences from this commentary. Possible preferences that text analytics may glean from the user's reviews include a dislike for greasy food and long waits, concern about cost, a love for good atmosphere and scenery, and an interest in hamburgers. While these preferences are gleaned from reviews of restaurants, these preferences may be applied to user's review requests that fall outside of restaurants or related fields.

In addition to including relevant reviews in the personalized aggregate review, the system may assign a priority to each review that the system determines to be more applicable. Reviews with higher priority may be displayed at the top of a list within the display of the personalized aggregate review or higher priority reviews may be displayed in another prominent way designed to catch the user's attention. In some examples, the reviews with the highest rating may be assigned the highest priority. In situations where the ratings of different reviews are equal, other factors may adjust priority. For example, a user's confidence in a review may serve as a tie breaker that gives a review a slightly higher priority.

User confidence may be determined from factors such as the source of the review, like a credible website. User confidence may also be determined by the reviewer. For example, a reviewer may be determined to have a higher user confidence when other reviews post positive remarks about the reviewer. A reviewer's history may also be taken into consideration. Also, user confidence may also be determined by the similarities between the user and reviewer.

Similarities between a user and reviewer may be identified through matching preferences within the user's profile and the information in the reviewer's profile. For example, if the user and reviewer have both rated the same product or service the same, the system may assign a higher confidence level to that reviewer and any of his or her reviews. Also, the system may assign a higher user confidence to a reviewer who has a similar age, residence, interest, or other preference. Also, similarities between the user's and the reviewer's word choice, style, and amount of commentary may be analyzed.

In the example of FIG. 6, the online review (600) contains commentary (601) that identifies factors important to the reviewer, such as quality of food, interest in hamburgers and French-fries, a dislike for grease, dislike of long waits, and an interest in scenery. Several of the factors that appear important to the reviewer happen to match several preferences in the reviews authored by the user and contained in the user's profile. Thus, the system may assign a higher confidence to the online review (600). Additionally, the user and the reviewer both gave a similar rating to restaurants that appear to be similar indicating more in common between the user and the reviewer. Thus, the system may assign a higher confidence to review (600).

In some examples, the origin of a review may be matched with the user's preferences. For example, the origin of a review may include factors such as where the reviewer created the review and when the review was created. FIG. 6 discloses that online review (600) was created in 2005. Thus, the system may assign a higher confidence to review (600) for the remainder of 2005 and the next couple of years. However, aged reviews may be assigned a lower confidence as the review's content may become less reliable over time. Also, online review (600) contains metadata that discloses the reviewer residence of Fort Collins, Colo., which is within the same state as the user. Thus, online review (600) may receive a higher confidence for having another similarity with the user.

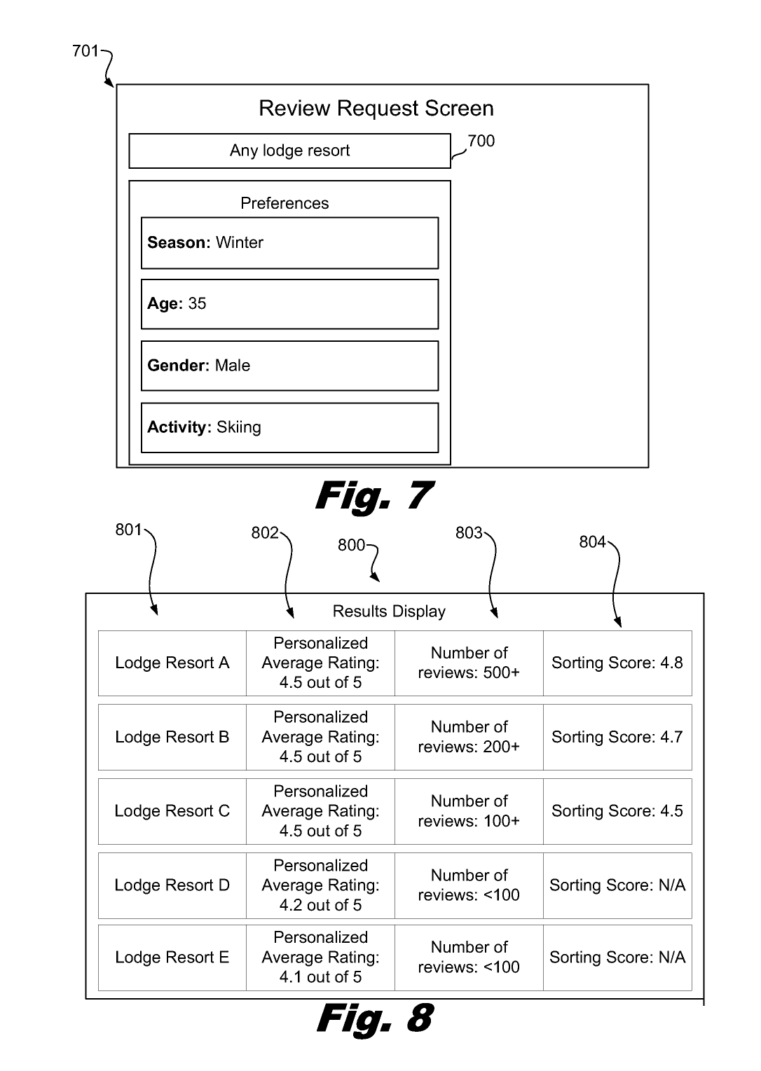

In the example of FIG. 7, the request field (700) on the request screen (701) contains a request criterion for “any lodge resort,” thus, the aggregate review will likely contain reviews about multiple lodge resorts. Use of the term “any” is used for illustrative purposes to clearly teach that the request criterion intends to include all lodge resorts. However, it should be understood that the any standard search system or technique may be incorporated with the present invention.

FIG. 8 discloses an illustrative display (800) that displays the preferred reviews in categories (801) of different lodge resort. Within each category (801) an average personalized rating (802) is displayed that contains an average of just the ratings of the reviews within that category. The personalized average rating also determines the reviews placement within a numeric order that the categories (801) are displayed. However, in the example of FIG. 8, Lodge Resorts A, B, and C each contain the same personalized average rating. Thus, a sorting score (803) for these categories is assigned based on a confidence factor (804). In the example of FIG. 8, the confidence factor (804) is the number of reviews within each category. While the confidence factor (804) and sorting score (803) is shown within the display (800) in the example of FIG. 8, in other examples the confidence factor and/or the sorting score may be hidden.

In some examples, a user must click on the category to view the individual reviews within the categories. In other examples, the individual reviews are automatically viewable to the user within the results display (800).

In some examples, the user may have the option to choose the confidence factor (803). A nonexclusive list of possible confidence factors may include similarities between the user and the reviewer, a single preference, multiple preferences, the source of the reviews, age of the reviews, the geographic locations where the reviews were created, the length of time that a product or service has been on the market, and the amount of experience that a user has with the product or service. Confidence factors may be used to determine the order that categories or the preferred reviews themselves are order on the customized display.

A nonexclusive list of possible preferences may include similarities between the user and the reviewer, the length of time that a product or service has been on the market, the amount of experience that a user has with the product or service, cost, product or service reliability, cleanliness of business or product, professionalism of service providers or salesmen, age, season, location, product lifespan, gender, community association, occupation, interests, and combinations thereof.

In some examples, the system uses only preferences that are expressly requested by the user as shown in the example of FIG. 1b. Some examples may include only inherent preferences, such as preferences that are tied to a user's profile. In some examples, online resources may also be a source for inherent preferences, such as public databases, social networking sites, and news articles about the user or about information known about the user, such as new articles about the user's hometown. In some examples, the inherent preferences may be selected or unselected to give the user freedom to search reviews as the user desires. Further, some examples of the present invention include preferences that include both expressly requested preferences and inherent preferences. The preferences may be used to include and/or exclude reviews from the personalized aggregate review. In some examples, the preferences are used to customize how the reviews are presented to the user, such as how prominent a review is presented in the review or the order in which the review is presented relative to the other reviews. In some examples, both preferred and non-preferred reviews are included in the customized display, and the preferences are used to display the preferred reviews more prominently in a useful manner for the user.

While the present invention is disclosed with specific reference to online websites and capabilities, the present invention may be used in any application that contains ratings and text reviews. The present invention may be applied to reviews for specific products or services or general classes of products and services.

The descriptions of the various examples of the present invention have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

1. A method for processing reviews, comprising:
with a processor:
identifying reviews that match a request criterion in a request from a user;
filtering said identified reviews using preferences and characteristics of said user; and
outputting a compilation of only those reviews filtered according to preference and characteristics of said user.

2. The method of claim 1, wherein outputting a compilation of only those reviews filtered according to preferences and characteristics of said user includes displaying filtered reviews sorted by review categories.

3. The method of claim 2, wherein displaying filtered reviews sorted by review categories includes ordering review categories in a numeric order based on a number of sorted reviews within said category.

4. The method of claim 2, wherein displaying filtered reviews sorted by review categories includes ordering review categories in a numeric order based on a sorting score assigned to each category.

5. The method of claim 1, wherein outputting a compilation of only those reviews filtered according to preferences and characteristics of said user includes displaying an average numeric rating of said filtered reviews.

6. The method of claim 1, wherein outputting a compilation of only those reviews filtered according to preferences and characteristics of said user includes ordering preferred reviews in a numeric order based on a sorting score assigned to each review.

7. The method of claim 1, wherein filtering said identified reviews using preferences and characteristics of said user includes preferences and characteristics expressly identified by said user.

8. The method of claim 1, wherein filtering said identified reviews using preferences and characteristics of said user includes preference and characteristics disclosed in a profile of said user.

9. The method of claim 1, wherein filtering said identified reviews using preferences and characteristics of said user includes preference and characteristics disclosed within a online resource created by said user.

10. The method of claim 1, wherein filtering said identified reviews using preferences and characteristics of said user includes preference and characteristics that relate to similarities between said user and said reviewer.

11. The method of claim 1, wherein filtering said identified reviews using preferences and characteristics of said user includes matching preference and characteristics with metadata located within a commentary within said review.

12. The method of claim 1, wherein filtering said identified reviews using preferences and characteristics of said user includes matching preference and characteristics with details about an origin of said review.

13. A system for processing reviews, comprising:
at least one processor to access and execute computer readable instructions stored on a computer readable storage medium;
said computer readable instructions to cause said at least one processor to, upon execution of said computer readable instructions:
identify reviews that match a request criterion in a request from a user;
filter said identified reviews using preferences and characteristics of said user; and
output a compilation of only those reviews filtered according to preference and characteristics of said user.

14. The system of claim 13, wherein said processor is further programmed to customize said compilation to include displaying filtered reviews sorted by review categories.

15. The system of claim 13, wherein said processor is further programmed to customize said compilation to display an average numeric ratings of said filtered reviews.

16. The system of claim 13, wherein said processor is further programmed to identify preferences and characteristics expressly identified by said user.

17. The system of claim 13, wherein said processor is further programmed to identify preferences and characteristics that relate to similarities between said user and said reviewer.

18. The method of claim 13, wherein said processor is further programmed to match a preferences and characteristics with metadata located within a commentary within said review.

19. A computer program product, comprising:
a computer readable storage medium, said computer readable storage medium comprising computer readable program code embodied therewith, said computer readable program code comprising:
computer readable program code to identify reviews that match a request criterion in a request from a user;
computer readable program code to filter said identified reviews using preferences and characteristics of said user; and
computer readable program code to output a compilation of only those reviews filtered according to preference and characteristics of said user.

20. The computer program product of claim 19, further computer readable program code to display an average of said numeric ratings of said filtered reviews.
